(19) United States
(12) Patent Application Publication
(10) Pub. No.: US 2016/0006871 A1
(43) Pub. Date: Jan. 7, 2016

(54) SYSTEM AND METHOD FOR MANAGING RESOURCES IN AN ENTERPRISE

(71) Applicant: Avaya Inc., Santa Clara, CA (US)

(72) Inventors: Neil O'Connor, Galway (IE); Tony McCormack, Galway (IE); Yvonne Aherne, Galway (IE)

(21) Appl. No.: 14/323,432

(22) Filed: Jul. 3, 2014

(51) Int. Cl. H04M 3/51; H04M 3/523

(52) U.S. Cl. CPC H04M 3/5175; H04M 3/5235; H04M 3/5233

(57) ABSTRACT

A call manager system for managing resource allocation for a call in an enterprise is disclosed. The call manager system includes a monitoring module configured to monitor one or more parameters of the call, wherein each parameter of the one or more parameters comprises a parameter value. The call manager system further includes a computing module configured to generate a justification value based on the parameter value of the monitored parameters. The call manager system further includes an allocating module configured to allocate one or more resources to the call based on the justification value. The call manager system further includes a display module configured to display one or more visual representations for a current status of the parameter values of the monitored parameters.

### BACKGROUND

1. Field

Embodiments of the present invention generally relate to a system and method to manage resources in an enterprise and particularly to a system and method for managing resource allocation for a call in the enterprise.

2. Description of Related Art

Contact centers are employed by many enterprises to service inbound and outbound contacts from customers. A primary objective of contact center management is to ultimately maximize contact center performance and profitability. An ongoing challenge in contact center administration is monitoring and optimizing contact center efficiency usage of its available resources. The contact center efficiency is generally measured by metrics such as Service Level Agreement (SLA), Customer Satisfaction (CSAT), and match rate. Contact center resources may include, agents, communication assets (e.g., number of voice trunks, number and bandwidth of video trunks, etc.), computing resources (e.g., a speed, a queue length, a storage space, etc.), and so forth.

Service level is one measurement of the contact center efficiency. Service level is typically determined by dividing the number of contacts accepted within a specified period by the number accepted plus number that were not accepted, but completed in some other way (e.g., abandoned, given busy, canceled, flowed out). Service level definitions may vary from one enterprise to another.

Match rate is another indicator used in measuring the contact center efficiency. Match rate is usually determined by dividing the number of contacts accepted by a primary skill level agent within a period of time by the number of contacts accepted by any agent in a queue over the same period. An agent with a primary skill level is one who typically may handle contacts of a certain nature more effectively and/or efficiently as compared to an agent of lesser skill level. There are other contact center agents who may not be as proficient as the primary skill level agent, and those agents are identified either as skill level agents or backup skill level agents. As can be appreciated, contacts received by a primary skill level agent are typically handled more quickly and accurately or effectively (e.g., higher revenue attained) than a contact received by a secondary or even backup skill level agent. Thus, it is an objective of most contact centers to optimize match rate along with the service level.

In addition to service level and match rate performance measures, contact centers use other Key Performance Indicators (“KPIs”), such as revenue, estimated, actual, or predicted wait time, average speed of answer, throughput, agent utilization, agent performance, agent responsiveness and the like, to calculate performance relative to their Service Level Agreements (“SLAs”). Operational efficiency is achieved when the KPIs are managed near, but not above, SLA threshold levels.

Throughput is a measure of the number of calls/contact requests or work requests that may be processed in a given amount of time. Agent utilization is a measure of how efficiently the agents' time is being used. Customer service level is a measure of the time customers spend waiting for their work to be handled. Company contact center customers wish to provide service to as many requests as possible in a given amount of time, using the least number of agents to do so, and minimizing the wait time for their customers that may increase the Service Level Agreement (SLA) of the contact center. Further, the contact center may also have to maintain the Customer Satisfaction (CSAT) metrics in order to maintain the KPIs of the contact center. For this purpose, agents may have to maintain the quality of services provided to the customers through multimedia (e.g., voice calls, video calls, emails, etc.).

Generally, to maintain the match rate and other business goals, a set of reserve agents is created in the contact centers. The set of reserve agents can include agents who are very skilled or highly skilled in a particular field such as in sales, complaints, and so forth. The set of reserve agents can also include supervisors or managers of the contact centers. Conventionally, reserve agents are only utilized at times when a value of a particular business goal has moved out of a predefined threshold. The threshold, such as an oldest call waiting, a service level percentage, or an Estimated Wait Time (EWT) is used to trigger the set of reserve agents of the contact center. For example, if an agent ‘A’ is busy in a car loan sales call and a number of contacts are in a waiting queue, then an oldest call waiting (e.g., more than 2 minutes) is routed to a reserve agent to handle the call. However, in these techniques, reserve agents are enabled to answer future incoming calls only if all the available agents are busy on service calls.

Further, supervisors of the contact center provide assistance to agents in existing calls that are not going well. One way to intervene in the call is where the supervisors observe and/or barge-in the call that is not going well. The supervisors observe the calls and based on their experience and personal knowledge about the agent handling the call, an agent is triggered to intervene in the call to get the call back on track. However, these conventional techniques require supervisors to manually observe ongoing calls and also do not take into account multiple factors while activating the agents of the contact center. Also, in conventional techniques, the set of reserve agents is used at the time of sudden influx of agents, i.e., at the time when number of agents available in the contact center is less.

There is thus a need for a system and method for managing resources in contact centers to improve handling of service calls.

### SUMMARY

Embodiments in accordance with the present invention provide a call manager system for managing resource allocation for a call in an enterprise. The call manager system includes a monitoring module configured to monitor one or more parameters of the call, wherein each parameter of the one or more parameters comprises a parameter value. The call manager system further includes a computing module configured to generate a justification value based on the parameter values of the monitored parameters. The call manager system further includes an allocating module configured to allocate one or more resources to the call based on the justification value.

Embodiments in accordance with the present invention further provide a computer-implemented method for managing resource allocation for a call in an enterprise. The method includes monitoring one or more parameters of the call, wherein each parameter of the one or more parameters comprises a parameter value, generating a justification value for the call based on the parameter values of the monitored parameters, comparing the justification value with a predefined threshold, and allocating one or more resources to the call based on the predefined threshold.

Embodiments in accordance with the present invention further provide a computer-implemented method for managing resource allocation for a call in an enterprise. The method includes monitoring one or more parameters of the call, wherein each parameter of the one or more parameters comprises a parameter value, generating a justification value for the call based on the parameter values of the monitored parameters, comparing the justification value with a predefined threshold, allocating one or more resources to the call based on the predefined threshold, and displaying one or more visual representations for a current status of the parameter values of the monitored parameters.

Embodiments of the present invention may provide a number of advantages depending on its particular configuration. First, the present application provides a system and a method for managing resource allocation for a call by allocating one or more resources in the call that is relatively not going well. Next, the present application provides a visual feedback or a representation of parameter values of the parameters that may help the supervisor to manage existing service calls in the contact center. Further, the present application utilizes the set of reserve agents to intervene in existing calls and to get the call back on track.

These and other advantages will be apparent from the present application of the embodiments described herein.

The preceding is a simplified summary to provide an understanding of some aspects of embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1A illustrates a block diagram depicting a contact center, according to an embodiment of the present invention;

FIG. 1B illustrates a high level hardware abstraction of a block diagram of a server, according to an embodiment of the present invention;

FIG. 2 illustrates a functional block diagram of the server that may be used in the contact center, according to an embodiment of the present invention;

FIG. 3 depicts a flowchart of a method for managing resources allocated for a call in the contact center, according to an embodiment of the present invention;

FIGS. 4A and 4B depict a flowchart of a method for managing resources allocated for a call in the contact center, according to another embodiment of the present invention; and

FIG. 5 illustrates a visual representation of monitored parameters of the call, according to an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention will be illustrated below in conjunction with an exemplary communication system, e.g., the Avaya Aura® system. Although well suited for use with, e.g., a system having an Automatic Call Distribution (ACD) or other similar contact processing switch, embodiments of the present invention are not limited to any particular type of communication system switch or configuration of system elements. Those skilled in the art will recognize the disclosed techniques may be used in any communication application in which it is desirable to provide improved contact processing.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read.

A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, embodiments may include a tangible storage medium or distribution medium and prior art-recognized equivalents and successor media, in which the software embodiments of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

The term “switch” or “server” as used herein should be understood to include a private Branch Exchange (PBX), an ACD, an enterprise switch, or other type of communications system switch or server, as well as other types of processor-based communication control devices such as media servers, computers, adjuncts, etc.

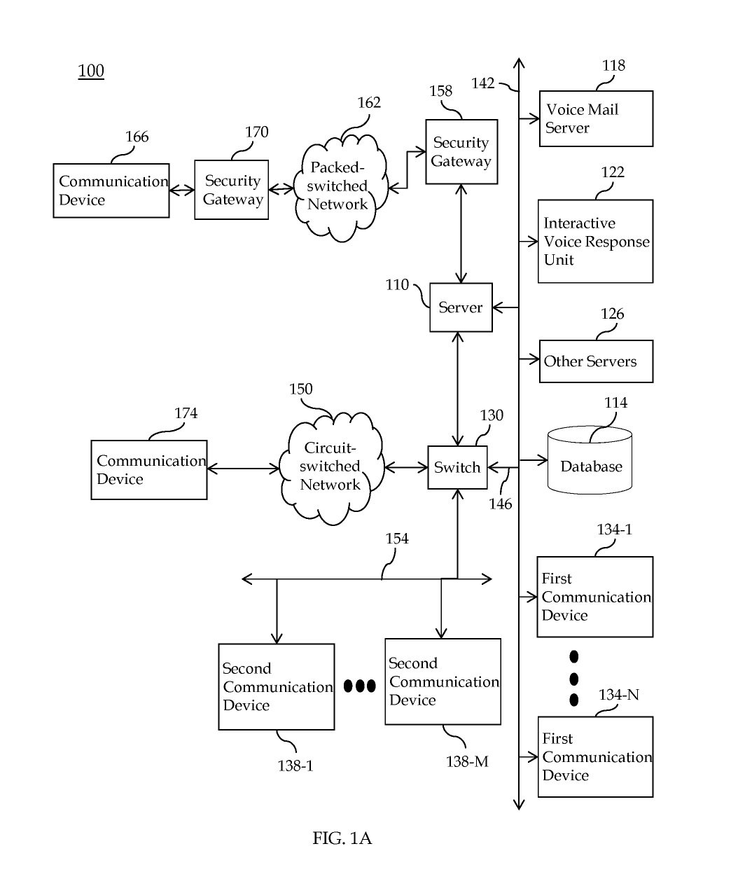

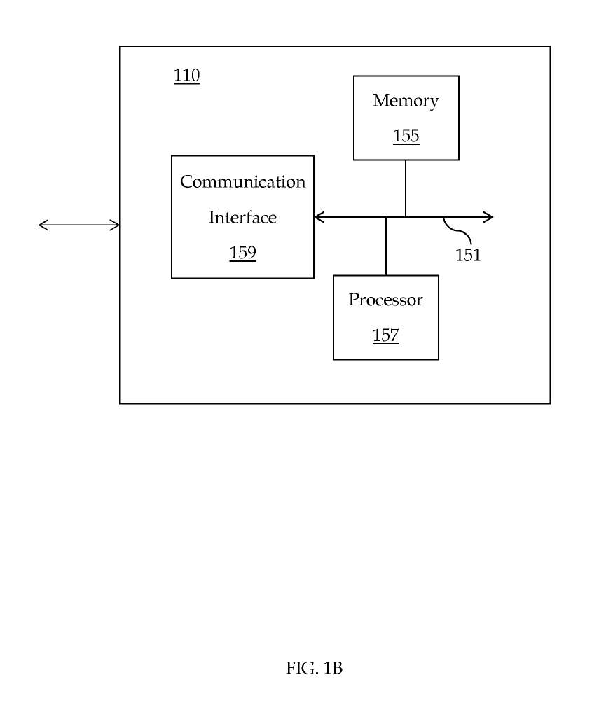

FIG. 1A shows an illustrative embodiment of the present invention. A contact center 100 comprises a server 110, a set of data stores or databases 114 containing contact or customer related information, resource or agent related information and other information that may enhance the value and efficiency of the contact processing, and a plurality of servers, namely a voice mail server 118, an Interactive Voice Response unit (e.g., IVR) 122, and other servers 126, a switch 130, a plurality of working agents operating packet-switched (first) communication devices 134-1-N (such as computer work stations or personal computers), and/or circuit-switched (second) communication devices 138-1-M, all interconnected by a Local Area Network (LAN) 142, (or Wide Area Network (WAN)). In another embodiment of the present invention, the customer and agent related information may be replicated over multiple repositories.

The servers may be connected via optional communication lines 146 to the switch 130. As will be appreciated, the other servers 126 may also include a scanner (which is normally not connected to the switch 130 or Web Server), VoIP software, video call software, voice messaging software, an IP voice server, a fax server, a web server, an email server, and the like. The switch 130 is connected via a plurality of trunks to a circuit-switched network 150 (e.g., Public Switch Telephone Network (PSTN)) and via link(s) 154 to the second communication devices 138-1-M. A security gateway 158 is positioned between the server 110 and a packet-switched network 162 to process communications passing between the server 110 and the packet-switched network 162. In an embodiment of the present invention, the security gateway 158 (as shown in FIG. 1A) may be Avaya Inc.'s, G700 Media Gateway™ and may be implemented as hardware such as via an adjunct processor (as shown) or as a chip in the server 110.

The switch 130 and/or server 110 may be any architecture for directing contacts to one or more communication devices. In some embodiments of the present invention, the switch 130 may perform load-balancing functions by allocating incoming or outgoing contacts among a plurality of logically and/or geographically distinct contact centers. Illustratively, the switch 130 and/or server 110 may be a modified form of the subscriber-premises equipment sold by Avaya Inc. under the names Definity™ Private-Branch Exchange (PBX) based ACD system, MultiVantage™ PBX, Communication Manager™, S8300™ media server and any other media servers, SIP Enabled Services™, Intelligent Presence Server™, and/or Avaya Interaction Center™, and any other products or solutions offered by Avaya or another company. Typically, the switch 130/server 110 is a stored-program-controlled system that conventionally includes interfaces to external communication links, a communications switching fabric, service circuits (e.g., tone generators, announcement circuits, etc.), memory for storing control programs and data, and a processor (i.e., a computer) for executing the stored control programs to control the interfaces and the fabric and to provide ACD functionality. Other types of known switches and servers are well known in the art and therefore not described in detail herein.

The first communication devices 134-1-N are packet-switched and may include, for example, IP hardphones such as the Avaya Inc.'s, 4600 Series IP Phones™, IP softphones such as Avaya Inc.'s, IP Softphone™, Personal Digital Assistants (PDAs), Personal Computers (PCs), laptops, packet-based H.320 video phones and conferencing units, packet-based voice messaging and response units, packet-based traditional computer telephony adjuncts, peer-to-peer based communication devices, and any other communication device.

The second communication devices 138-1-M are circuit-switched devices. Each of the second communication devices 138-1-M corresponds to one of a set of internal extensions Ext-1-M, respectively. The second communication devices 138-1-M may include, for example, wired and wireless telephones, PDAs, H.320 videophones and conferencing units, voice messaging and response units, traditional computer telephony adjuncts, and any other communication devices.

It should be noted that the embodiments of present invention do not require any particular type of information transport medium between switch, or server and first and second communication devices, i.e., the embodiments of the present invention may be implemented with any desired type of transport medium as well as combinations of different types of transport channels.

The packet-switched network 162 may be any data and/or distributed processing network, such as the Internet. The packet-switched network 162 typically includes proxies (not shown), registrars (not shown), and routers (not shown) for managing packet flows.

The packet-switched network 162 as shown in FIG. 1A is in communication with a first communication device 166 via a security gateway 170, and the circuit-switched network 150 with an external second communication device 174.

In one configuration, the server 110, the packet-switched network 162, and the first communication devices 134-1-N are Session Initiation Protocol (SIP) compatible and may include interfaces for various other protocols such as the Lightweight Directory Access Protocol (LDAP), H.248, H.323, Simple Mail Transfer Protocol (SMTP), IMAP4, ISDN, E1/T1, and analog line or trunk.

It should be emphasized that the configuration of the switch 130, the server 110, user communication devices, and other elements as shown in FIG. 1A is for purposes of illustration only and should not be construed as limiting embodiments of the present invention to any particular arrangement of elements.

Further, the server 110 is notified via the LAN 142 of an incoming service request or work item by the communications component (e.g., switch 130, a fax server, an email server, a web server, and/or other servers) receiving the incoming service request as shown in FIG. 1A. The incoming service request is held by the receiving telecommunications component until the server 110 forwards instructions to the component to forward or route the contact to a specific contact center resource, such as the IVR unit 122, the voice mail server 118, and/or first or second telecommunication device 134-1-N, 138-1-M associated with a selected agent.

FIG. 1B illustrates at a relatively high-level hardware abstraction of a block diagram of a server such as the server 110, in accordance with an embodiment of the present invention. The server 110 may include an internal communication interface 151 that interconnects a processor 157, a memory 155 and a communication interface circuit 159. The communication interface circuit 159 may include a receiver and transmitter (not shown) to communicate with other elements of the contact center 100 such as the switch 130, the security gateway 158, the LAN 142, and so forth. By use of programming code and data stored in the memory 155, the processor 157 may be programmed to carry out various functions of the server 110.

Although embodiments are discussed with reference to client-server architecture, it is to be understood that the principles of embodiments of the present invention apply to other network architectures. For example, embodiments of the present invention apply to peer-to-peer networks, such as those envisioned by the Session Initiation Protocol (SIP). In the client-server model or paradigm, network services and the programs used by end users to access the services are described. The client side provides a user with an interface for requesting services from the network, and the server side is responsible for accepting user requests for services and providing the services transparent to the user. By contrast in the peer-to-peer model or paradigm, each networked host runs both the client and server parts of an application program. Additionally, embodiments of the present invention do not require the presence of packet- or circuit-switched networks.

The term “switch” or “server” as used herein should be understood to include a Private Branch Exchange (PBX), an ACD, an enterprise switch, an enterprise server, or other type of telecommunications system switch or server, as well as other types of processor-based communication control devices such as media servers, computers, adjuncts, etc.

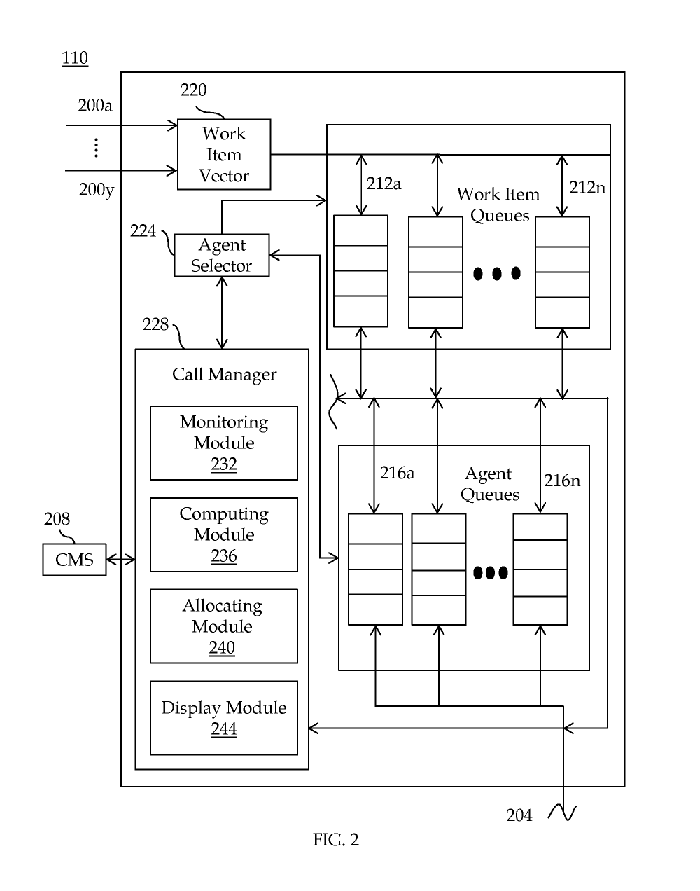

Referring to FIG. 2, one possible configuration of the server 110 is depicted at a relatively high level of functional abstraction, according to an embodiment of the present invention. The server 110 is in communication with a plurality of contact or customer communication lines 200a-y (which may be one or more trunks, phone lines, etc.) and an agent communication line 204 (which may be a voice-and-data transmission line such as the LAN 142 and/or a circuit switched voice line). The server 110 may include Avaya Inc.'s an Operational Analyst™ (OA) with On-Line Analytical Processing (OLAP) technology or a Call Management System (CMS) 208 that gathers contact records. OA and CMS will hereinafter be referred to jointly as CMS 208.

As shown in FIG. 2, among the data stored in the server 110 is a set of contact or work item queues 212a-n and a separate set of agent queues 216a-n. Each contact queue 212a-n corresponds to a different set of agent queues, as does each agent queue 216a-n. Conventionally, contacts are prioritized and either are queued in individual ones of the contact queues 212a-n in their order of priority or are queued in different ones of a plurality of contact queues that correspond to a different priority. Likewise, each agent's queues are prioritized according to his or her level of expertise or skill in that queue, and agents are queued in either individual ones of agent queues 216a-n in their order of expertise level or in different ones of a plurality of agent queues 216a-n that correspond to a queue and each one of which corresponds to a different expertise level. In an embodiment of the present invention, the agent queue 216a-n may include a set of reserve agents queue in the contact center 100.

According to an embodiment of the present invention, included among the control programs in the server 110 is a work item vector 220. Contacts or calls incoming to the contact center 100 are assigned by the work item vector 220 to different work item queues 212a-n based upon a number of predetermined criteria, including customer identity, customer needs, contact center needs, current contact center queue lengths, customer value, and the agent skill that is required for proper handling of the contact. Agents who are available for handling work items are assigned to the agent queues 216a-n based upon the skills that they possess. An agent may have multiple skills, and hence may be assigned to multiple agent queues 216a-n simultaneously. Furthermore, an agent may have different levels of skill expertise (e.g., skill levels 1-N in one configuration or merely primary skill levels and secondary skill levels in another configuration), and hence may be assigned to different agent queues 216a-n at different expertise levels.

In one configuration, the contact center 100 is operated by a contract operator (e.g., a supervisor or a manager of the contact center 100), and each of the work item queues 212a-n, and possibly each of the agent queues 216a-n, corresponds to a different client. Each client may have a separate Service Level Agreement (SLA) or other type of performance measurement agreement with the contract operator regarding performance expectations, goals, requirements or specifications for the client's respective queue(s).

Further, embodiments in accordance with the present invention may include, among the programs executing on the server 110, an agent selector 224 and a call manager 228. The agent selector 224 and the call manager 228 are stored either in the main memory or in a peripheral memory (e.g., disk, CD ROM, etc.) or some other computer-readable medium of the contact center 100. Further, the agent selector 224 monitors the occupants of the work item and agent queues 212a-n and 216a-n, respectively, and contact center objectives, rules, and policies and assigns agents to service work items.

The agent selector 224 distributes and connects these work items to communication devices of available agents based on the predetermined criteria noted above. When the agent selector 224 forwards a contact (or first work item) to an agent, the agent selector 224 also forwards customer-related information from the database 114 to the agent's desktop or computer work station for previewing and/or viewing (such as by a pop-up display) to enable the agent for providing better services to the customer. Depending on the contact center configuration, the agent selector 224 may reallocate the work items to the agents of the contact center 100. The agents process the contacts or work items sent to them by the agent selector 224.

In an embodiment of the present invention, the agent and their associated data are maintained and updated in the database 114 of the contact center 100. Upon the completion of handling a work item, a generator (not shown) collects selected metrics for the work item. These metrics may include skills involved in servicing the work item, an identifier of a servicing agent, contact duration, a transaction or contact type (e.g., sale, information request, complaint, etc.), time-of-day, result of the call (e.g., type of sale, number of units sold, an average revenue generated, etc.), and so forth. The metrics along with other statistics is typically gathered by the CMS 208.

In an exemplary embodiment of the present invention, the call manager 228 is configured to monitor parameters of the call. The parameters of the call may include, but is not restricted to, a type of call, an importance of a customer, agent skill set, a sentiment type of customer or an agent, to name a few. Further, the call manager 228 is configured to compute a justification value for the monitored parameters, which is then compared with a predefined threshold. Further, the call manager 228 is configured to generate and display graphical or visual representations to display current parameter values of the parameters. Also, the call manager 228 is configured to allocate resources to an ongoing call when any value of the parameters of the call is more than the predefined threshold.

According to an embodiment of the present invention, the call manager 228 includes certain modules, such as, but is not restricted to, a monitoring module 232, a computing module 236, an allocating module 240, and a display module 244. In some embodiments, one or more of the monitoring module 232, the computing module 236, the allocating module 240 and the display module 244 may be implemented by one or more software processes running on the server 110. The server 110 may implement one or more software processes by use of the processor 157 being suitably programmed by use of software instructions stored in the memory 155 coupled to the processor 157.

The monitoring module 232 may monitor details of a call such as a type of call to the contact center 100 according to an embodiment of the present invention. The type of the call, i.e., whether the call made by a customer is a voice call, a video call, a text message, an email, an instant messaging, a Voice over Internet Protocol (VoIP), and so forth. Further, the monitoring module 232 may monitor static details about the call, for example, inputs selected by the customer in an IVR menu of the contact center 100. For example, if a customer selects a button “3” for a ‘life insurance’ in an IVR menu and further selects a button “7” for an ‘inquiry’, then the monitoring module 232 may determine the customer desires to inquire about a life insurance policy. In another embodiment of the present invention, the monitoring module 232 may monitor conversation between the customer and an agent handling the call. The monitoring module 232 may then extract keywords from the conversation between the customer and the agent such as the customer is inquiring about a health insurance policy then “health insurance” and “inquiry” may be extracted as keywords from the conversation.

The monitoring module 232 may further collect a profile and data of an agent of the contact center 100 handling the call, in an embodiment of the present invention, wherein the agent data for providing customer services is obtained by the contact center 100 in several ways and from several sources. A primary source for collecting the agent data may be the contact center 100. However, information included in the agent data may provide a limited view of the overall characteristics of the agent, specifically the characteristics of the agent with respect to the contact center 100. The agent profile may include, but is not restricted to, an agent's self-description, skill sets, likes, locations etc. The agent's skill sets may include, but is not restricted to, an agent's interests, education and work histories, technical training, experience in supporting a particular industry, company, or a customer, to name a few. The agent skill set may also include hobbies, hometowns, favorite sport teams and TV shows, cultural background, and so on, to the extent such information may be relevant to support the customers of the contact center 100. In an embodiment of the present invention, the agent profile may be stored and maintained in the database 114 of the contact center 100.

As used herein, the term “agent skill set” may refer to the set of agent data that is used by the contact center 100 to characterize an agent. Such agent data may include, but is not restricted to, biographical agent data, demographic agent data, and external or internal behavioral agent data, to name a few. The behavioral data may include the agent's history with respect to the contact center 100 and/or any other entity or social media channel. However, the agent data is not limited in this regard and may include any other type of agent data used by the contact center 100 to characterize or classify agents. Further, the agent data may include any other agent data collected from one or more sources external to the contact center 100. Additionally, the agent profile may be raw data or processed agent data. That is, the agent data may be analyzed to characterize the agent and thereafter used to provide customized or personalized services to the customer. For example, an agent profile may be a set of values associated with an agent and a set of characteristics, where the values are selected based on the agent data obtained. However, the present application is not limited in this regard and any other methods for evaluating agent data to provide services that may be used without limitation.

Accordingly, in another embodiment of the present invention, a secondary source of agent data may be utilized, e.g., social media channels. For example, the contact center 100 may be configured to access and monitor social media channels (not shown) to help in determining skills of the agent. The profile and data of the agent of the contact center 100 may be updated automatically at configurable intervals according to an embodiment of the present invention.

In an embodiment of the present invention, the agents of the contact center 100 may be characterized based on their skill sets. For example, gold rated agents are agents who are very skilled in a particular field (e.g., home loans) and handle incoming calls with high quality, whereas silver rated agents are agents who may have only basic skill level, and there is no guarantee that those calls will be handled at same quality provided by the gold rated agents.

Further, the monitoring module 232 may monitor importance of the customer of the call based on a profile of the customer in an embodiment of the present invention. The importance of the customer may be rated as a high value customer, a medium value customer, or a low value customer. A customer who provides higher revenue to the contact center 100, for example, a customer purchases products (e.g., life insurance) having higher margins or revenue to the contact center 100 may be referred to as a high value customer. Next, a customer who provides less revenue to the contact center 100, for example, a customer purchases products (e.g., pet insurance) that may provide low margins to the contact center 100, may be referred to as a low value customer. A medium value customer may be a customer who may have products (e.g., car insurance) of a medium value to the contact center 100. In another embodiment of the present invention, the monitoring module 232 may monitor the importance of the customer based on a reason of the call, i.e., whether the call is a sales call, a complaint call, an inquiry call, and so forth.

In an embodiment of the present invention, the importance of the customer may change during the call. For example, if the customer is having a pet insurance policy and is now enquiring about a life insurance policy that may have a higher margin then the importance of the customer increases from a low value customer to a medium value customer. In case, if the customer purchases the life insurance policy then the value of the customer may further change to a high value customer.

The monitoring module 232 may detect a sentiment type of the customer or the agent during the call. The sentiment type may be, but is not restricted to, a positive sentiment and a negative sentiment. The positive sentiments indicate that the customer is happy and satisfied from the call. The negative sentiments indicate that the customer is unhappy and unsatisfied from the call that may further be associated with a lost sale. It may be possible that the agent handling the call is not very skilled (silver rated agent). Hence, the agent may not be skilled enough to satisfy the customer. Further, if the customer is already having some complains then the agent may face difficulty in handling the call.

The monitoring module 232 may detect the sentiment type of the customer or the agent from start of call up to an end of the call in an embodiment of the present invention. For example, sentiments at the start of the call may be okay but deteriorate as the call proceeds. The monitoring module 232 may also detect the sentiment type in the text messages, emails, or instant messaging. In an embodiment of the present invention, for a voice call, a sentiment detector (not shown) may be plugged into a media server or gateway of the contact center 100 to detect the sentiment type. In another embodiment of the present invention, a text analyzer (not shown) may be used for text related media, e.g., a web chat, a text message, and the forth to detect the sentiment type during the call. In an embodiment of the present invention, the monitoring module 232 may also record the call.

The computing module 236 may compute a justification value for the call based on parameter values of the monitored parameters of the call. The justification value may indicate performance of the call in an embodiment of the present invention. The monitored parameters of the call may include, but is not restricted to, a type of the call, an agent skill set, an importance of a customer, a sentiment type of an agent or a customer, and so forth. The computing module 236 may further compute an inverse of the skill level of the current agent handling the call, or similarly normalised values for any of the monitored parameters. In an embodiment of the present invention, each of the parameters of the call comprises a parameter value. In an embodiment of the present invention, values of the parameters may change during the call. Parameter values of the monitored parameters are then manipulated to generate a justification value for the call. The justification value may be considered as a function of current parameter values of the monitored parameters in an embodiment of the present invention. In an embodiment of the present invention, the justification value may be a cumulative value of the monitored parameters over duration of the call.

The computing module 236 may generate the justification value based on a strategy associated with the incoming call. The strategy may be associated with the call on a per-call basis, or a per-service basis, in an embodiment of the present invention. The per-call based strategy may be associated with a profile of the customer. For example, if the customer of the call is a Very Important Person (VIP) because of its status and importance such as a renowned industrialist has called for an inquiry of a low margin product, for example, a pet insurance policy then the justification value for the call is calculated by taking into account the profile of the customer. The per-service based strategy may be associated with a service provided by the contact center 100. For example, if the contact center 100 provides health insurance policies to customers, then all services associated with the policy such as sales, complaints, etc. are considered while computing the justification value for the call. The computing module 236 may be a Work Assignment Engine (WAE) (not shown) of the contact center 100. In an embodiment of the present invention, the computing module 236 may compute the justification value for the call by using a mathematical algorithm. The computing module 236 may compute the justification value for the call by using different mathematical algorithms for each of the parameters of the call, in another embodiment of the present invention.

Further, the computing module 236 may compare the justification value with a predefined threshold. In an embodiment of the present invention, the predefined threshold may be a normalized value for the performance of the call. If the justification value is below the predefined threshold, then it is determined that the agents are handling the call in a satisfactory manner. Otherwise, it is determined that there is a need to add an additional resource in the exiting call to get the call back on track. In another embodiment of the present invention, the computing module 236 may determine allocation of the additional resources based on a sharpness of movement of the current parameter values displayed in the visual representation, i.e., the computing module 236 may determine allocation of resources based on a rate of change of the parameter values of the monitored parameters during the call. For example, if sentiments of the customer suddenly changes from positive to negative sentiments, then it is determined that an additional resource is required to intervene in the call.

Further, the computing module 236 may identify genres of calls that may have required intervention of the resources in the call. For example, for a duration of time (e.g., 8:00 AM to Noon) calls related to health insurance complaints are handled by silver rated agents and the calls are not going well, then it is identified that calls related to the health insurance complaints frequently require intervention of resources in the calls.

The allocating module 240 may select and allocate resources to intervene in the call. In an embodiment of the present invention, the allocating module 240 may allocate one or more additional resources in the call. The selected resource may be, but is not restricted to, a supervisor, an agent, a reserve agent, a Subject Matter Expert (SME), to name a few. In an embodiment of the present invention, the allocating module 240 may select and allocate the resources based on some factors such as, but is not restricted to, a personality type, gender, an accent, and so forth, in order to compute a magnitude of positive impact on the customer who may require assistance. In an embodiment of the present invention, the allocating module 240 may automatically allocate an additional resource in the call if the justification value of the call is more than the predefined threshold. In an exemplary embodiment of the present invention, if negative sentiment of the customer is increasing, then an additional resource is added in the call to receive positive outcomes from the call.

The allocating module 240 may allow a manual intercept on the decision to include an additional resource in the call, i.e., the supervisor of the contact center 100 may override the proceeding with an addition of the resource, in another embodiment of the present invention. For example, a gold rated agent is handling an incoming call but the justification value is more than the predefined threshold and a red flashing icon is displayed on the supervisor's desktop then the supervisor may override the decision to add an additional resource in the call as a very skilled agent is already handling the call and therefore, allow a latitude in the visual representation before adding the additional resource. Further, the allocating module 240 may route the call to the selected resource to handle the call. In an embodiment of the present invention, the allocation module 240 may route the call to suitable resources to handle the call, based on the identified genres of the calls. For example, if justification values of calls related to health insurance complaints are above the predefined threshold and often require intervention of the resources then other incoming calls may be initially routed to resources having proficiency to handle calls related to the health insurance complaints. Therefore, the allocation module 240 may improve routing of the calls in the contact center 100 to ensure that the calls are correctly routed to most suitable agents of the contact center 100.

The display module 244 may generate visual or graphical representations for the justification value in an embodiment of the present invention. The visual representation may include pie charts, bar charts, line charts, histograms etc. The visual representation of the parameters of the call may be a single dimensional, or a multi-dimensional representation. The display module 244 may display the generated graphical or visual representation for the justification value in an embodiment of the present invention. X-axis of the visual representation may indicate magnitude of the monitored parameters and Y-axis may indicate the justification value that displays a need to add an extra resource or an agent to intervene into the call and to manage the call. The visual representation may display predefined desired shapes or curves of the parameters of the call. In an embodiment of the present invention, a first curve in the visual representation may indicate an importance of a customer, a second curve may indicate a sentiment type, and a third curve may indicate an inverse of skill level of current agent, i.e., a less skilled agent may have a higher parameter value than a very skilled agent. For example, a silver rated agent may have a higher parameter value than a gold rated agent. Further, a horizontal bar may indicate a predefined threshold for the parameter values of the monitored parameters. The shape of the curves in the visual representation depends on desired business goals (e.g., CSAT, higher revenue etc.) of the contact center 100. For example, a predefined shape of desired parameter values of the parameters is displayed in the visual representation. In an embodiment of the present invention, as parameter values of the monitored parameters change then the shape of the visual representation may also change during the call. However, the parameters are not limited in this regard and may include other type of parameters used by an enterprise based on business rules and/or business goals of the enterprise.

Further, the current status of the parameters of the call based on a current call handling strategy of the contact center 100 is displayed in the visual representation through a mark such as a dot. As discussed above, the parameters of the call may change during the call, which therefore changes the justification value for the call. This change may be indicated by a movement (up or drop) of the dot in the visual representation. For example, if negative sentiments of the customer are detected then a dot on the curve of a sentiment type parameter may move up, on the other hand if positive sentiments are detected, the dot may move down. In an exemplary embodiment of the present invention, the display module 244 may display the visual representation in a real time environment, i.e., positions of the dots are continuously changing based on the monitored parameters of the call. In another embodiment of the present invention, area under the curves of the shape of the monitored parameters in the visual representation may be used to compute the justification value for the call, wherein the visual representation may then provide a current status for an overall skill, or for contacts being handled by a virtual group of agents.

The display module 244 may display the shape of the monitored parameters of the call in different colors in the visual representation in an embodiment of the present invention. In an exemplary embodiment of the present invention, shape of an importance of a customer parameter is displayed in red color, shape of the sentiment type parameter is displayed in green color, or shape of agent skills set parameter is displayed in black color in the visual representation. Further, the display module 244 may generate alerts and display notifications to the supervisor if values of the parameters of the call deteriorates or is more than the predefined threshold in yet another embodiment of the present invention. The display module 244 is configured to generate a plurality of alerts comprising beeps, flash, and popup.

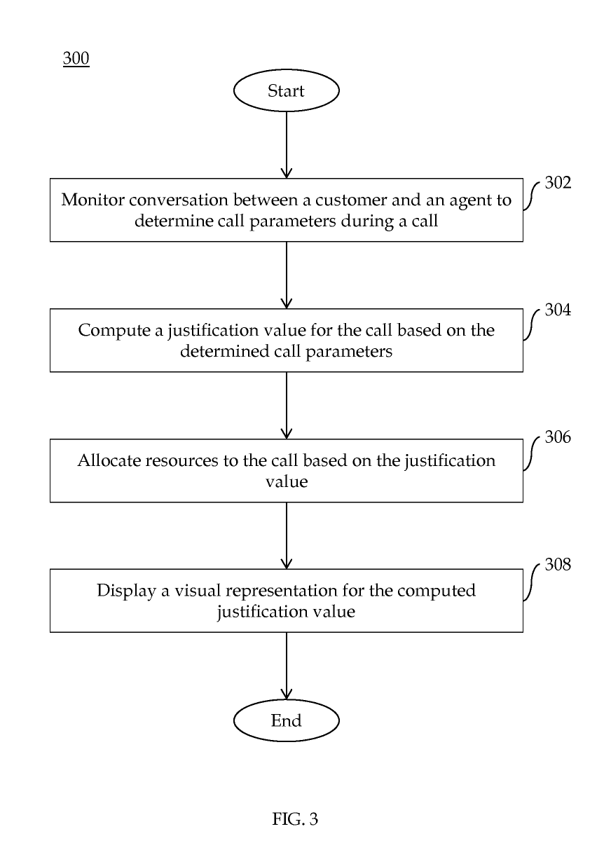

FIG. 3 depicts a flowchart of a method for managing resource allocation for a call in the contact center 100, according to an embodiment of the present invention.

At step 302, a call manager 228 monitors conversation between a customer and an agent to determine parameters during a call. The parameters of the call may include, but is not restricted to, type or details of the call, an agent skill set, an importance of a customer, a sentiment type of a customer or an agent, and so forth. The details of the call may include, a type of call, i.e., whether the call made by the customer is a voice call, a video call, a text message, an email, an instant message, a Voice over Internet Protocol (VoIP), and so forth. Further, static details about the call are also monitored, for example, inputs selected by the customer in an IVR menu of the contact center 100.

The agent skill set may refer to a set of agent data that may be used by the contact center 100 to characterize an agent. Such agent data may include, but is not restricted to, biographical agent data, demographic agent data, and external or internal behavioral agent data, to name a few. Further, the sentiments may include, but is not restricted to, positive sentiments and negative sentiments. The positive sentiments indicate that the customer is happy and satisfied from the call. The negative sentiments indicate that the customer is unhappy and unsatisfied from the call. The importance of the customer may be indicated as a high value customer, a medium value customer, or a low value customer. Also, the call manager 228 may extract keywords from the conversation between the customer and the agents. In an embodiment of the present invention, the parameters of the call may be monitored in a real time environment.

At step 304, the call manager 228 computes a justification value for the call based on the determined parameters. The justification value may indicate an overall performance of the call between the customer and the agent handling the call. In an embodiment of the present invention, each of the determined parameters of the call comprises a parameter value. Parameter values of each of the determined parameters are then used to compute a justification value for the call. In an embodiment, any mathematical or statistical functions may be used to compute the justification value from the parameter value. The mathematical or statistical functions may be, but not limited to, a mean, an average, a weighted average, a standard deviation, or their combinations. In an embodiment of the present invention, the call manager 228 computes the justification value based on a strategy associated with the call such as per-call basis, or a per-service basis. The call manager 228 may compute the justification value for the call by using a mathematical algorithm, or by using different mathematical algorithms for each of the parameters of the call, in an embodiment of the present invention. Further, the call manager 228 compares the justification value with a predefined threshold.

Next, at step 306, the call manager 228 allocates resources based on the justification value. In an embodiment of the present invention, the resources may be allocated to the call to intervene in the call. The selected and allocated resource may be, but is not restricted to, a supervisor, an agent, a reserve agent, a Subject Matter Expert (SME), to name a few. In an embodiment of the present invention, the call manager 228 selects and allocates resources based on some factors such as, but is not restricted to, a personality type, gender, an accent, and so forth in order to improve handling of the call. Further, the call manager 228 routes the call to the selected resource to handle the call.

At step 308, the call manager 228 generates and displays graphical or visual representations for the determined parameters of the call. The visual representation may include, but is not restricted to, a pie chart, a bar chart, a line chart, a histogram etc. The visual representation of the parameters of the call may be a single dimensional or a multi-dimensional representation. The visual representation displays current parameter values of each parameter of the determined parameters. The visual representation may also display the justification value of the call which indicated a need to add an additional resource to improve handling of the call. In an exemplary embodiment of the present invention, X-axis of the visual representation indicates a magnitude of the determined parameters and Y-axis indicates the justification value.

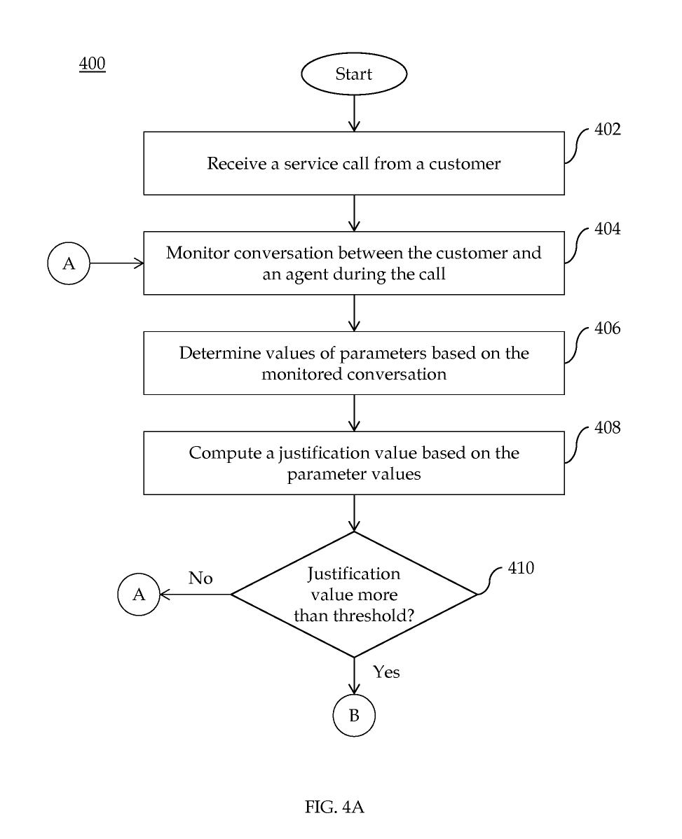

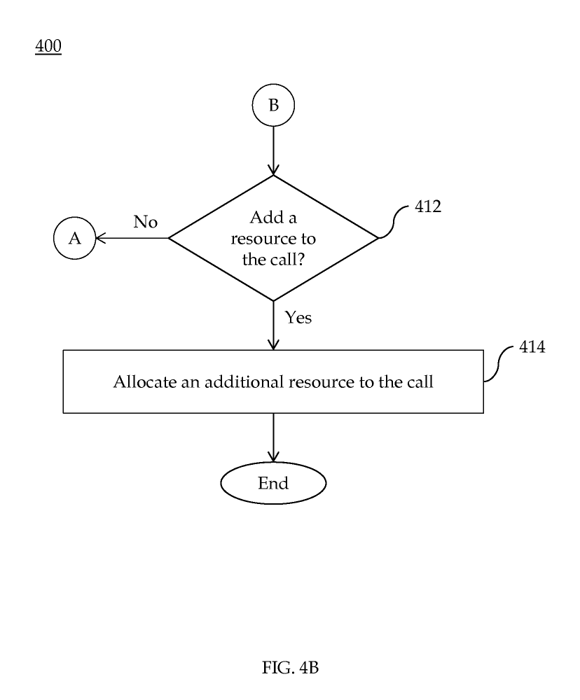

FIGS. 4A and 4B depict a flowchart of a method 400 for managing resource allocation for a call in the contact center 100, according to another embodiment of the present invention.

At step 402, a call manager 228 receives a service call from a customer. In an embodiment of the present invention, the service call may include a voice contact, e.g., a telephone call to the contact center 100. In another embodiment of the present invention, the call may include an email, a text message, an instant message, a video call, or a Voice over Internet Protocol (VoIP).

At step 404, the call manager 228 monitors conversations between a customer and an agent during the call. In an embodiment of the present invention, the call manager 228 retrieves information such as, a type of the call, i.e., a video call, a text message, a voice call, etc. Further, static details of the call may be monitored. For example, inputs selected by the customer in an IVR menu of the contact center 100 may be monitored. For example, if the customer selects ‘healthcare option’ in an IVR menu and further selects ‘claims inquiry’, then ‘healthcare’ and ‘claims inquiry’ may be stored as parameters of the call.

Further, the call manager 228 monitors other parameters of the call, for example, an agent skill set, an importance of a customer, a sentiment type of the customer and the agent, and so forth. The agent skill set may refer to a set of agent data that may be used by the contact center 100 to characterize an agent. Such agent data may include, but is not restricted to, biographical agent data, demographic agent data, and external or internal behavioral agent data, to name a few. Further, the sentiment type may include, but is not restricted to, a positive sentiment and a negative sentiment. The positive sentiment indicates that the customer is happy and satisfied from the call. The negative sentiment indicates that the customer is unhappy and unsatisfied from the call. The importance of the customer may be rated as a high value customer, a medium value customer, or a low value customer. Also, the call manager 228 may also extract keywords from the conversation between the customer and the agents.

Next, at step 406, the call manager 228 determines values of monitored parameters based on the monitored conversation. In an embodiment of the present invention, each parameter of the determined parameters comprises a parameter value. The call manager 228 determines current values of the monitored parameters of the service call. In an embodiment of the present invention, the values of the parameters of the call may be determined in a real time environment.

At step 408, the call manager 228 computes a justification value based on the determined values of the parameters. The justification value may indicate an overall performance of the call between the customer and the agent handling the call. The parameter values of each of the monitored parameters are then manipulated to compute a justification value for the call. The justification value may be considered as a function of current parameter values of the parameters. In an embodiment of the present invention, the call manager 228 computes the justification value based on a strategy associated with the incoming call such as per-call basis, or a per-service basis. The call manager 228 may compute the justification value for the call by using a mathematical algorithm, or by using different mathematical algorithms for each of the parameters of the call, in another embodiment of the present invention.

Thereafter, at step 410, the call manager 228 determines whether the justification value is more than a predefined threshold. If the justification value is less than the predefined threshold, then the monitoring of the call is continued, until the call finishes. Otherwise, if the justification value is above the predefined threshold, then the method 400 proceeds towards step 412. In an embodiment of the present invention, a notification, or an alert (e.g., a red flashing icon) is displayed on the supervisor's desktop to take necessary actions if the justification value is more than the predefined threshold.

Further, at step 412, the call manager 228 determines whether to add a resource to the call. In an exemplary embodiment of the present invention, if a gold rated agent is handling the call and the justification value of the call breaches the predefined threshold, then it may be determined that the call may continue as a very skilled agent is handling the call, and therefore the method 400 returns to the step 404. Otherwise, the method 400 proceeds towards step 414.

At step 414, the call manager 228 selects and allocates a resource to intervene in the call. The resource may be, but is not restricted to, a supervisor, an agent, a reserve agent, a Subject Matter Expert (SME), to name a few. In an embodiment of the present invention, the call manager 228 suggests and allocates an agent based on some factors such as, but is not restricted to, a personality type, gender, an accent, and so forth, to compute a magnitude of positive impact on the customer who may require assistance during the service call.

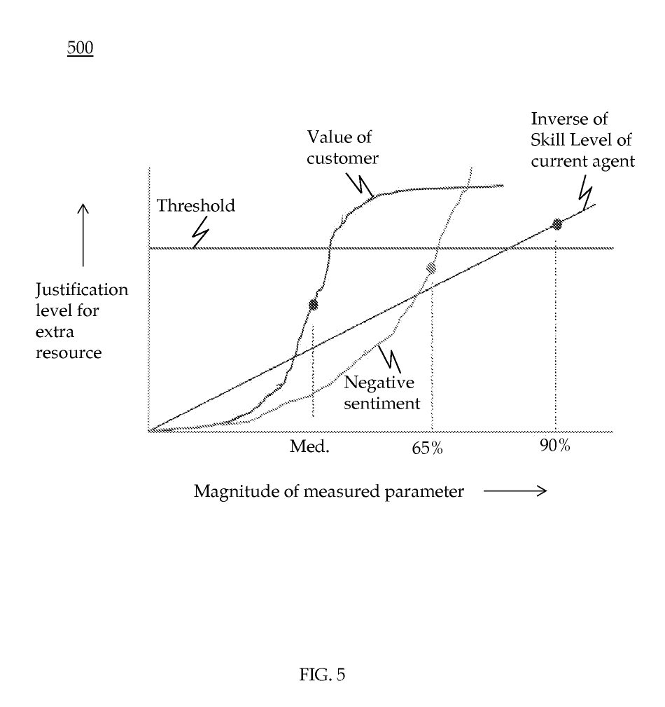

FIG. 5 illustrates a visual representation 500 of monitored parameters of the call in the contact center 100 according to an embodiment of the present invention. The lines, curves, or values displayed in the visual representation 500 are exemplary, and a person skilled in the art will appreciate that various different visual representations are possible. In an exemplary embodiment of the present invention, X-axis of the visual representation indicates a magnitude of monitored parameters and Y-axis of the visual representation indicates a justification level that displays a need to add an extra resource, or an agent to intervene and manage an existing call. Further, a horizontal bar indicates a predefined threshold for parameter values of the monitored parameters. The visual representation further displays predefined desired shapes or curves of the parameters of the call.

As shown in the FIG. 5, a first curve indicates an importance of a customer parameter, a second curve indicates a negative sentiment parameter, and a third curve indicates an inverse of skill level of current agent parameter, i.e., a silver rated agent have a higher parameter value than a gold rated agent. For example, if proficiency of the agents in the contact center 100 is rated by a value from 1 to 16, i.e., an agent with a value 1 is a very skilled agent in a particular skill set and an agent with a value 16 may be a trainee, or a silver rated agent with less skills in that particular field and may have a normalized value of 100%. Also, a dot on the curve may display a current parameter value of the agent handling the call. The dot may slide to the left hand side if the agent is a gold rated agent, or the dot may slide to the right hand side if the agent is a silver rated agent. The magnitude of inverse of skill level of current agent is 90% then it is determined that the agent handling the call is a less skilled agent.

Further, 65% is normalized sentiment type of the customer. If sentiments of the customer on the call are negative, then a dot on the negative sentiment curve may move towards the right hand side. And if the sentiments of the customer are positive, then the dot on the negative sentiment curve may move towards the left hand side. In an embodiment of the present invention, if negative sentiments of the customer are increasing then supervisors have to interfere in the call to recover the customer's sentiments to positive sentiments and to handle the call. Further, an importance of a customer parameter curve in the visual representation indicates importance of the customer based on a product range (low margin products to high margin products) associated with the customer.

If the product range is high then a dot representing current value of the customer moves to the right hand side, otherwise the dot moves in the opposite direction. The current values of the parameters indicated by the dots are then manipulated, for example, added, multiplied, etc., to compute a justification value for the call. If the justification value is breached the predefined threshold, an immediate action has to be taken to handle the call. As shown in the FIG. 5, the dot of the inverse of skill level of the current agent breaches the predefined threshold while other two dots are below the predefined threshold, this means the existing call justifies the need of having an additional resource in the call. Therefore, an additional resource is allocated to intervene in the call.

The exemplary embodiments of this present invention have been described in relation to a contact center. However, to avoid unnecessarily obscuring the present invention, the preceding description omits a number of known structures and devices. This omission is not to be construed as a limitation of the scope of the present invention. Specific details are set forth by use of the embodiments to provide an understanding of the present invention. It should however be appreciated that the present invention may be practiced in a variety of ways beyond the specific embodiments set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network.

It will be appreciated from the preceding description, and for reasons of computational efficiency, the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, changes, additions, and omissions to this sequence can occur without materially affecting the operation of embodiments of the present invention.

A number of variations and modifications of the present invention can be used. It would be possible to provide for some features of the present invention without providing others.

For example in one alternative embodiment of the present invention, the systems and methods of this present invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, non-volatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with embodiments of the present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, it is not limited to such standards and protocols. Other similar standards and protocols not mentioned herein are in existence and considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. It is not intended to limit the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A call manager system for managing resource allocation for a call in an enterprise, the call manager system comprising:
a monitoring module configured to monitor one or more parameters of the call, wherein each parameter of the one or more parameters comprises a parameter value;
a computing module configured to generate a justification value based on the parameter values of the monitored parameters; and
an allocating module configured to allocate one or more resources to the call based on the justification value.

2. The call manager system of claim 1, wherein the call comprises at least one of a voice call, a video call, an email, an instant message, a text message, and a Voice over Internet Protocol (VoIP).

3. The call manager system of claim 1, wherein parameters of the call comprise at least one of an importance of a customer, a sentiment type of a customer or an agent, an agent skill set, and a skill level of a current agent.

4. The call manager system of claim 3, wherein the computing module is further configured to compute an inverse of the skill level of the current agent, or similarly normalised values for any of the monitored parameters.

5. The call manager system of claim 1, wherein the computing module is further configured to compare the justification value with a predefined threshold.

6. The call manager system of claim 1, wherein the justification value is a cumulative value of the parameter values over a duration of the call.

7. The call manager system of claim 1, further comprising a display module configured to generate and display one or more visual representations for a current status of the parameter values of the monitored parameters of the call.

8. The call manager system of claim 1, wherein the parameter values of the monitored parameters change during the call.

9. The call manager system of claim 1, wherein the computing module is configured to determine allocation of the one or more resources based on a rate of change of the parameter values of the monitored parameters during the call.

10. The call manager system of claim 1, wherein the one or more resources are allocated when the justification value is more than the predefined threshold.

11. The call manager system of claim 1, wherein the one or more resources is one of a reserve agent, an agent, a supervisor, or a Subject Matter Expert (SME).

12. The call manager system of claim 1, wherein the allocation module is further configured to select the one or more resources based on one or more factors to improve handling of the call, wherein the factors comprise at least one of a personality type, gender, or an accent.

13. The call manager system of claim 1, wherein the allocation module is further configured to enable manual override of the allocation.

14. A computer-implemented method for managing resource allocation for a call in an enterprise, the method comprising:
monitoring one or more parameters of the call, wherein each parameter of the one or more parameters comprises a parameter value;
generating a justification value for the call based on the parameter values of the monitored parameters;
comparing the justification value with a predefined threshold; and
allocating one or more resources to the call based on the threshold.

15. The method of claim 13, wherein parameters of the call comprise at least one of an importance of a customer, a sentiment type of a customer or an agent, an agent skill set, and a skill level of a current agent.

16. The method of claim 14, further computing an inverse of the skill level of the current agent.

17. The method of claim 14, further comprising identifying a genre of calls that require additional resources.

18. The method of claim 13, wherein the parameter values of the monitored parameters of the call change during the call.

19. The method of claim 13, further comprising displaying one or more visual representations for current status of the parameter values of the monitored parameters of the call.

20. The method of claim 13, wherein the one or more resources is one of a reserve agent, an agent, a supervisor, or a Subject Matter Expert (SME).

21. A computer-implemented method for managing resource allocation for a call in an enterprise, the method comprising:
monitoring one or more parameters of the call, wherein each parameter of the one or more parameters comprises a parameter value;
generating a justification value for the call based on the parameter values of the monitored parameters;
comparing the justification value with a predefined threshold;
allocating one or more resources to the call based on the threshold; and
displaying one or more visual representations for a current status of the parameter values of the monitored parameters.

22. The method of claim 19, wherein parameters of the call comprise at least one of an importance of a customer, a sentiment type of a customer or an agent, an agent skill set, and a skill level of a current agent.
